(19) United States
(12) Patent Application Publication
(10) Pub. No.: US 2004/0014848 A1
(43) Pub. Date: Jan. 22, 2004

(54) Organic Hydrophicizing agent for aluminiferous metals

(76) Inventors: Kazuya Tanaka, Yokohama-shi (JP); Kazunari Hamamura, Sagamihara-shi (JP); Ryouji Morita, Hiratsuka-shi (JP)

Correspondence Address: HENKEL CORPORATION, THE TRIAD, SUITE 200, 2200 RENAISSANCE BLVD., GULPH MILLS, PA, 19406, US

(21) Appl. No.: 10/380,121

(22) PCT Filed: Sep. 6, 2001
(86) PCT No.: PCT/US01/28020

(30) Foreign Application Priority Data
Sep. 11, 2000 (JP) 2000-280152

(51) Int. Cl. C08K 5/15; C08K 5/05

(52) U.S. Cl. 524/107; 524/384

(57) ABSTRACT

The surface of aluminiferous metal is coated with a treatment agent that contains

(A) water-soluble polymer having a main chain to which is bonded at least one functional group selected from carboxyl groups, amide groups, hydroxyl groups, sulfonic acid groups, and phosphonic acid groups; and

(B) phenolic compound in which a total of at least five OH groups are directly bonded to a polycyclic structure that contains at least one aromatic ring structure

Optionally, (C) a glycidyl-functional organic compound is also present. A hydrophilic coating is formed on the aluminiferous metal surface by heating to solidify or dry the treatment agent.

### FIELD OF THE INVENTION

This invention relates to an organic hydrophilicizing agent for use for the hydrophilicization of the surfaces of aluminiferous metals, including both aluminum and aluminum alloys, and to a treatment method that uses this organic hydrophilicizing agent. More particularly, this invention relates to an organic hydrophilicizing agent that can form a highly hydrophilic, highly odor evolution resistant, and highly deodorizing coating on aluminiferous metals and to a method for treating aluminiferous metals using said organic hydrophilicizing agent. The organic hydrophilicizing agent and treatment method of this invention are used in particular in the automotive sector and for household electrical appliances and are particularly well suited for the fabrication of the aluminum heat exchanger fins used in air conditioners.

### DESCRIPTION OF THE RELATED ART

Compositions are already known for the formation of hydrophilic coatings on the surface of the aluminum fins used in heat exchangers. These compositions include aqueous solutions of organic polymers, aqueous solutions of organic polymer and surfactant, and aqueous solutions whose base component is an inorganic compound such as silica or an alkali silicate. A hydrophilic coating can be formed on an aluminum surface by applying these compositions to aluminiferous metal by dipping or roll coating followed by heating and drying.

As part of efforts to achieve greater energy conservation, there have also been extensive technical developments with regard to reducing fin pitch in order to achieve greater heat exchanger compactness and imparting hydrophilicity and a durable hydrophilicity to heat exchanger surfaces in order to improve the heat exchange efficiency.

The unpleasant odors produced by air conditioner heat exchangers have also been a matter of great concern. A strong inorganic odor (e.g., a dusty odor or cement smell) that engenders an unpleasant sensation is produced by the aforementioned inorganic compound-based hydrophilic coatings.

The coating itself evolves little odor in the case of the aforementioned organic polymer-based hydrophilic coatings. However, microorganisms such as mold and bacteria grow on these coatings during long term service and these microorganisms produce unpleasant odors (e.g., the odor of rotting). This elaboration of unpleasant odor is particularly pronounced in high-temperature, high-humidity ambients. Methods employed to avoid this problem include the advance addition of antimicrobial to the hydrophilicizing agent and directly spraying antimicrobial on the heat exchanger using, for example, an anti-odor spray. The addition of very small amounts of antimicrobial can inhibit the rotting odor, but these antimicrobials are not always nontoxic for the individuals who handle them.

The addition of active carbon to the hydrophilic coating is another method for dealing with the odor problem. The active carbon, which has an excellent adsorption capacity for odor substances, is added as an odor suppressant. This method, however, suffers from such problems as a poorer durability of the hydrophilicity and re-release of the adsorbed odor substances in high-humidity environments.

Unpleasant odor can also be produced when roll coating is employed in certain pre-coating sequences. In these sequences, a shaping operation is carried out after the hydrophilicizing agent has been roll coated on the surface of the aluminiferous metal and dried by heating. Under severe working conditions such as drilling, drawing, or ironing, an unpleasant odor can be produced by the friction occurring between the coating and the tool or die.

In the specific case of organic polymer-based coatings, coating degradation and unpleasant odor evolution can occur due to thermal degradation and thermal oxidative degradation induced by the heat of friction. Moreover, even when no odor is produced during the shaping operation itself, thermal degradation products from the organic polymer coating may remain on the coating surface or within the coating. These may be released and emitted during the initial period of air conditioner operation, causing the perception of unpleasant odors.

These various problems with unpleasant odor evolution can inflict discomfort on large numbers of people when they occur in the working environment during heat exchanger fabrication or in a room or compartment environment during air conditioner operation. Quite a few countermeasures for these odor problems have already been proposed.

For example, Japanese Patent Application Laid Open (Kokai or Unexamined) No. Hei 9-272819 (272,819/1997) discloses a hydrophilicizing composition for heat exchange service. However, this technology does not provide complete odor prevention because the coating afforded by the disclosed technology still evolves unpleasant odor.

Japanese Patent Application Laid Open (Kokai or Unexamined) No. Hei 8-232078 (232,078/1996) discloses a waterborne hydrophilicizing agent and a hydrophilicizing method for application to aluminiferous metals. The disclosed agent contains an antimicrobial as its essential component for preventing the evolution of unpleasant odor. This antimicrobial, however, is synthesized by chemical reaction and does not always have a low toxicity for humans.

Within the sphere of deodorization, Japanese Patent Application Laid Open (Kokai or Unexamined) No. Sho 62-90168 (90,168/1987) discloses a deodorizing filter while Japanese Patent Application Laid Open (Kokai or Unexamined) No. Hei 2-251681 (251,681/1990) discloses a method for processing a deodorizing fiber. These inventions do exhibit a deodorizing activity, but their applications and fields are entirely different from the technical field and applications of the present invention and they are unsuitable for the applications contemplated by the present invention. Japanese Patent Application Laid Open (Kokai or Unexamined) No. Hei 5-45083 (45,083/1993) discloses self-deodorizing aluminum heat exchanger fin stock. This material does not evolve unpleasant odor during press working. However, this invention employs water-dispersed silica. During long-term operation, the bound dew water occurring during cooling operations becomes a factor and the silica is unmasked on the coating surface. This unmasked silica produces an unpleasant inorganic odor.

Thus, up to now no composition has been disclosed that is capable of forming a hydrophilic coating that can simultaneously impart an excellent hydrophilicity, excellent resistance to odor evolution, and excellent deodorizing activity to the surface of aluminiferous metals.

### SUMMARY OF THE INVENTION

This invention seeks to solve the problems described above for the known art. The invention provides an organic hydrophilicizing agent that can form a hydrophilic coating that imparts an excellent hydrophilicity, an excellent resistance to odor evolution, and an excellent deodorizing activity to aluminiferous metal surfaces. The invention also provides a treatment method that uses this organic hydrophilicizing agent.

With regard to odor-related terminology, as used herein such terms as “resistance to odor evolution” and “odor evolution resistant” denote the absence of unpleasant odor evolution from the surface and bulk of hydrophilicized aluminum prepared using this invention. These terms also include the absence of unpleasant odor evolution as caused by the coating degradation products that can be produced by frictional heat during working. However, this resistance to odor evolution is intended to mean that the odor is at a level below that detectable by humans and is not intended to mean that there is absolutely no emission.

Terms such as “deodorization” and “deodorizing activity” refer to the ability of the organic hydrophilic coating formed on the aluminiferous metal, when present in an environment containing bad smelling substances (e.g., acetaldehyde, ammonia, trimethylamine, and mercaptans), to actively react with these substances and thereby reduce the level of such substances in the environment.

The inventive hydrophilicizing agent for aluminiferous metals comprises:

(A) at least one water-soluble polymer having a main chain to which is bonded at least one functional group selected from carboxyl groups, amide groups, hydroxyl groups, sulfonic acid groups, and phosphonic acid groups; and

(B) at least one phenolic compound in which a total of at least five hydroxyl groups are directly bonded to a polycyclic structure that comprises at least one aromatic ring structure.

The inventive hydrophilicizing agent for aluminiferous metals (hereinafter referred to simply as the inventive hydrophilicizing agent) preferably additionally contains (C) at least one glycidyl-functional organic compound.

### DETAILED DESCRIPTION OF THE INVENTION

The phenolic compound (B) in the inventive organic hydrophilicizing agent is preferably selected from polyhydroxy compounds with structural formula (I)

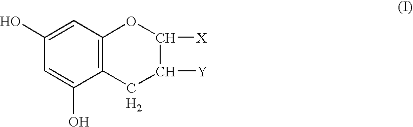

wherein:

X represents an aromatic group that is substituted by at least two hydroxyl groups and

Y is a hydroxyl group or an aromatic group with formula (II).

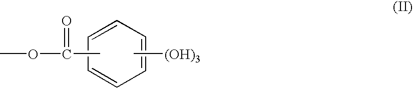

The polyhydroxy compound with general formula (I) in the inventive hydrophilicizing agent is preferably selected from (+)-catechin, (−)-epicatechin, (+)-gallocatechin, (−)-epicatechin gallate, (−)-epigallocatechin gallate, and (−)-epigallocatechin. Mixtures of polyhydroxyl compounds may be used.

The solids weight contents A, B, and C of the components (A), (B), and (C) in the inventive hydrophilicizing agent preferably satisfy one or both of the following relationships (1) and (2).

A:C=9:1 to 3:7 (1)

B:(A+C)=1:1000 to 1:20 (2)

In other words, the weight ratio of component (A) to component (C) is preferably within the range of 9:1 to 3:7. The weight ratio of component (B) to the total of components (A) and (C) is preferably within the range of 1:1000 to 1:20.

The method of this invention for the surface hydrophilicization of aluminiferous metals comprises the steps of:

applying the inventive hydrophilicizing agent to at least one surface of an aluminiferous metal; and

forming a hydrophilic coating layer on said surface by heating and drying the applied hydrophilicizing agent.

The water-soluble polymer (A) used in this invention is added to the agent primarily for the purpose of imparting a high level of hydrophilicity to the aluminiferous metal. This component (A) should contain at least 1 functional group selected from the group consisting of carboxyl groups, amide groups, hydroxyl groups, sulfonic acid groups, and phosphonic acid groups. The water-soluble polymer (A) may be synthesized by the polymerization under specified conditions (e.g., of heating, pressurization, and stirring) of ethylenically unsaturated monomer and/or oligomer bearing a hydrophilic group as specified above or a mixture of two or more different monomers and/or oligomers. Copolymers of hydrophilic group-containing monomers and oligomers with monomers and oligomers which do not bear hydrophilic groups may also be used.

The carboxyl-functional monomers and amide-functional monomers that can be used to produce the water-soluble polymer (A) can be exemplified by acrylic acid, methacrylic acid, crotonic acid, itaconic acid, maleic acid, fumaric acid, and acrylamide, including the salts of those compounds capable of forming salts. The salts can be exemplified by the alkali metal salts, e.g., sodium and potassium salts, and by the alkaline earth metal salts, e.g., magnesium and calcium salts, and by the ammonium salts.

The following are examples of substances which can be used as the sulfonic acid-functional monomers and phosphonic acid-functional monomers: vinylsulfonic acid, sulfoethyl acrylate, sulfoethyl methacrylate, N-methylsulfonic acid acrylamide, 2-acrylamido-2-methylpropanesulfonic acid, styrenesulfonic acid, vinylphosphonic acid, and phosphonoxyethyl methacrylate. Salts of the preceding can also be used, for example, alkali metal salts such as the sodium and potassium salts and alkaline earth metal salts such as the magnesium and calcium salts, and ammonium salts.

The hydroxyl-functional monomers can be exemplified by vinyl alcohol, 2-hydroxyethyl (meth)acrylate, 2-hydroxypropyl (meth)acrylate, and 3-hydroxypropyl (meth)acrylate.

The phenolic compound (B) has a polycyclic structure that includes at least one aromatic ring structure and at least five hydroxyl groups which are directly bonded to said polycyclic structure. This phenolic compound (B) is preferably selected from polyhydroxy compounds with structural formula (I), supra. The group X bonded at the 2 position in (I) is an aromatic group that is substituted by at least 2 hydroxyl groups and, for example, can be selected from (III) and (IV).

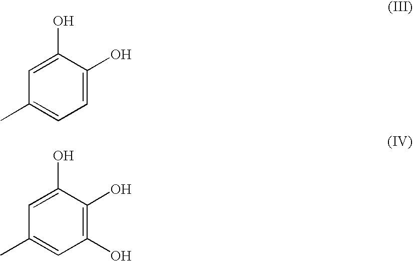

The group Y bonded at the 3 position represents a hydroxyl group or a trihydroxy-functional aromatic group with formula (II) and, for example, is preferably the aromatic group (IV). The phenolic compound (B) used by this invention can be exemplified by catechin, epicatechin, gallocatechin, epicatechin gallate, epigallocatechin, and epigallocatechin gallate.

The leaves of plants in the family Camelliaceae are a source of the phenolic compound (B). The phenolic compound (B) may be an extract from, for example, tea, tsubaki (Camellia japonica), rengyou (Forsythia suspensa), kinmokusei (Osmanthus fragrans var. aurantiacus), dokudami (Houttuynia cordata), or hisakaki (Eurya japonica) or may be a mixture of the aforementioned catechins as afforded by separation.

Regardless of the particular compositional ratio, all of the aforementioned catechin compounds provide a high resistance to odor evolution and a high deodorizing activity.

As necessary or desired the inventive agent may also contain a glycidyl-functional organic compound (C). Such compound contains at least one glycidyl group, more preferably at least two glycidyl groups, per molecule. Glycidyl-functional organic compounds that exhibit crosslinking reactivity with the carboxyl or amide groups present in the water-soluble polymer (A) may be used as the glycidyl-functional organic compound (C). Glycidyl derivatives of glycols and other polyols are one class of preferred glycidyl-functional organic compound. Usable polyglycidyl-functional compounds are, for example, sorbitol polyglycidyl ether, polyglycerol polyglycidyl ether, pentaerythritol polyglycidyl ether, triglycidyl triisocyanate, glycerol polyglycidyl ether, trimethylolpropane polyglycidyl ether, resorcinol diglycidyl ether, neopentyl glycol diglycidyl ether, 1,6-hexanediol diglycidyl ether, (poly)ethylene glycol diglycidyl ether, (poly)propylene glycol diglycidyl ether, and (poly)tetramethylene glycol diglycidyl ether. These glycidyl-functional organic compounds (C) bond with the reactive groups in the water-soluble polymer (A) and thereby insolubilize this polymer. The subject glycidyl-functional organic compounds (C) also react with the hydroxyl groups in the phenolic component (B), which either insolubilizes this component or renders it sparingly soluble.

The solids weight ratio A:C between the water-soluble polymer (A) and glycidyl-functional organic compound (C) present in the inventive hydrophilicizing agent is preferably from 9:1 to 3:7. While application and baking/drying do yield a hydrophilic coating at A:C weight ratios in excess of 9:1, the coatings obtained at such high A:C weight ratios may suffer from a somewhat poorer retention of their hydrophilicity in humid environments. However, the magnitude of this deficiency does not rise to a problematic level for most practical applications. When the A:C weight ratio is below 3:7, the resulting hydrophilic coating may suffer from such a substantial deterioration in the durability of its hydrophilicity that the coating is likely to present problems in practical applications.

With regard to the component (B) content in the hydrophilicizing agent, the solids weight ratio B:(A+C) is preferably from 1:1000 to 1:20. A satisfactory odor evolution resistance and a satisfactory deodorizing activity are generally not obtained when this ratio is less than 1:1000. The odor evolution resistance and deodorizing activity typically undergo no additional improvements at ratios in excess of 1:20, making such ratios uneconomical.

When present in an environment containing such offensive odor substances as acetaldehyde, acetic acid, ammonia, triethylamine, or mercaptans, the hydrophilic coatings afforded by application and heating/drying of the inventive hydrophilicizing agent on an aluminiferous surface have the ability to reliably reduce the level of such substances. Given in particular that these odor substances produce intensely unpleasant sensations in human living spaces, this deodorizing activity exhibited by the inventive hydrophilicizing agent should be extremely significant for practical applications.

The inventive hydrophilicizing agent may also contain a suitable addition of surfactant in order to improve the agent's coatability on aluminiferous metal surfaces and improve the durability of the hydrophilicity of the coating afforded by drying. The candidate surfactants can be broadly classified into anionic surfactants, amphoteric surfactants, and nonionic surfactants.

The anionic surfactants can be exemplified by the salts of sulfuric acid esters of higher alcohols, salts of sulfuric acid esters of higher alkyl ethers, salts of dialkyl sulfosuccinates, salts of alkylbenzenesulfonic acids, and salts of the phosphoric acid esters of higher alcohols.

The amphoteric surfactants can be exemplified by methyl laurylaminopropionate, laurylaminopropionic acid salts, lauryldimethylbetaine, stearyldimethylbetaine, and lauryldihydroxyethylbetaine. The nonionic surfactants can be exemplified by (poly)oxyethylene alkyl ethers, (poly)oxyethylene alkylphenyl ethers, (poly)ethylene glycols, (poly)ethylene-(poly)propylene glycol copolymers, and (poly)tetramethylene glycols.

The solids (non-volatile) concentration in the hydrophilicizing agent of this invention is not critical, but the range of 3 to 30% by weight is generally preferred. Water is typically used as the solvent or carrier for the hydrophilicizing agent, but water-soluble and/or water-imiscible organic solvents may also be present. Regardless of the solids concentration in the hydrophilicizing agent, the dry coating afforded by application and drying of the hydrophilicizing agent on the aluminiferous metal surface preferably has a weight in the range of 0.1 to 2.0 g/m². Uniform coverage of the aluminiferous metal surface usually cannot be obtained at a coating weight below 0.1 g/m², which may result in the emission in humid environments of an inorganic odor originating from aluminum oxide. No additional enhancements in effect are generally obtained at coating weights in excess of 2 g/m², making such coating weights uneconomical.

The procedure for applying the inventive hydrophilicizing agent is not critical, but this agent will typically be applied by roll coating, spraying or dipping. The maximum attained temperature of the coated workpiece during heating/drying should preferably be in the range of 180 to 260° C., and suitable drying times will typically be in the range of 10 seconds to 1 minute. Inactivation of the phenolic compound (B) often occurs at drying temperatures in excess of 260° C. and at drying times in excess of 1 minute, which can be expected to eliminate the odor evolution resistance and deodorizing activity. The hydrophilic coating is usually inadequately cured at drying temperatures below 180° C. and at drying times below 10 seconds, which can cause poor adherence and a deterioration in the hydrophilicity.

The hydrophilicizing agent of this invention may suitably be applied to aluminiferous metal on which a dry-in-place- or conversion-type anticorrosion surface preparation treatment has been preliminarily executed. These surface treatments are executed in order to improve the corrosion resistance and adherence to the hydrophilicizing agent and can be exemplified by phosphoric acid chromate treatments, chromic chromate treatments, zirconium-based nonchromate treatments, and titanium-based nonchromate treatments.

Heating and drying of the inventive hydrophilicizing agent causes the formation of a solid coating through solidification of the water-soluble polymer (A) upon drying, or causes a crosslinking reaction to occur through the ring-opening addition polymerization of the glycidyl-functional organic compound (C) with the carboxyl or amide groups present in the water-soluble polymer (A). This crosslinking reaction causes the formation of a three-dimensional network structure in the hydrophilicizing agent layer, which results in the production of an insolubilized coating.

Thermal degradation reactions and thermal oxidative degradation reactions can occur in the coating due to the heating concurrent with the aforementioned reaction, heating (overbaking) that continues after coating formation, or high temperature drying. However, the presence of the phenolic compound (B) apparently reduces this thermal degradation and thermal oxidative degradation and inhibits the production of the low molecular weight substances that are thought to be one factor in the evolution of unpleasant odors.

This same mechanism is believed to operate during the continuous press working of aluminiferous metal that has been hydrophilicized in accordance with this invention to prevent unpleasant odor evolution by inhibiting the degradative deterioration of the coating that can be induced by the frictional heat generated between the die or tool and the stock surface.

This inhibition of the unpleasant odor evolution attributable to thermal degradation and thermal oxidative degradation reactions is believed to be due to the antioxidation activity of the phenolic hydroxyls present in the skeleton of component (B). The thermal degradation and thermal oxidative degradation that occur after formation of the insolubilized coating are thought to be caused by radical reactions that result in accelerated cleavage of polymer end groups. The phenolic compound (B), functioning as an oxidation inhibitor, is balanced to inhibit these radical reactions. This inhibition of the thermal degradation of the insolubilized coating enables a maximal manifestation of the hydrophilicity and hydrophilicity durability native to the insolubilized coating.

The component (B) that stably remains in the insoluble coating has other characteristics: aside from long-term prevention of unpleasant odor evolution, this component is thought to exhibit and maintain a deodorizing activity by trapping unpleasant odor substances present in the ambient through chemical reactions.

### EXAMPLES

This invention is explained in further detail through the following examples.

### Examples 1 through 9 and Comparative Example 1

In each of Examples 1 through 9 and Comparative Example 1, precleaned aluminum sheet (JIS 1050, thickness=0.1 mm, width=20 mm, length=30 mm) was subjected to a phosphoric acid chromate treatment to give a chromium deposition of 20 mg/m². The inventive hydrophilicizing agent (composition reported in Table 1) was adjusted to a solids concentration of 10% and the resulting bath was applied with a roll coater on both of the chromated sides of the aluminum sheet. Post-application drying by heating to a maximum attained sheet temperature of 220° C. produced a hydrophilic coating with a dry coating weight of 1 g/m².

The properties of the resulting hydrophilic coatings were evaluated using the following tests and evaluation scales.

Property Evaluation Tests

(1) Hydrophilicity

5 μL of deionized water was dripped onto the surface of the coating on the hydrophilicized material. The contact angle of the resulting water drop was measured using a contact angle instrument (FACE BA-P from Kyowa Kaimen Kagaku Kabushiki Kaisha). The following two values were determined: the contact angle of the coating immediately after hydrophilicization (designated as the initial contact angle) and the contact angle of the coating after dipping for 100 hours in deionized water (designated as the elapsed time contact angle).

Evaluation scale

| | |
|---|---|
| ++ | the contact angle is less than 10° |
| + | the contact angle is at least 10° but less than 20° |
| Δ | the contact angle is at least 20° but less than 30° |
| x | the contact angle is at least 30° |

(2) Odor Evolution

Specimens carrying the hydrophilic coating were submitted to sensory testing by a five-person panel. The following two values were determined: odor evolution immediately after the hydrophilicizing treatment (designated as the initial odor evolution) and odor evaluation after dipping for 100 hours in deionized water (designated as the elapsed time odor evolution). In addition, a specimen was heated in an electric oven for 1 minute at 300° C. Odor evolution from the specimen (designated as the thermal odor evaluation) was then evaluated immediately after the specimen had been cooled to room temperature.

Evaluation scale

| | |
|---|---|
| ++ | absolutely no perception of offensive odor |
| + | slight perception of offensive odor but without reaction of |
| | discomfort; the type of offensive odor cannot be discerned |
| Δ | clear perception of offensive odor; the type of offensive odor can |
| | be discerned |
| x | strong perception of offensive odor and strong negative reaction |

(3) Deodorizing Activity

The specimen carrying the hydrophilicizing coating was cut to dimensions of 100×100 mm and was sealed in a 5-liter quartz glass container. The offensive odor material was then introduced in gaseous form into the container and was brought to the specified concentration. The change with elapsed time was monitored by measuring the initial gas concentration and the gas concentration after 30 minutes. The gas concentration was measured using a gas detection tube.

The initial concentrations of the offensive odor materials were as follows: ammonia=100 ppm, trimethylamine=50 ppm, and methyl mercaptan=10 ppm.

The deodorizing rate was calculated using the following equation from the concentrations for each offensive odor substance.

deodorizing rate (%)=(concentration (ppm) after 30 minutes)/(initial concentration (ppm))×100

Evaluation scale

| | |
|---|---|
| ++ | deodorizing rate ≧ 90% |
| + | 60% ≦ deodorizing rate < 90% |
| Δ | 30% ≦ deodorizing rate < 60% |
| x | deodorizing rate < 30% |

TABLE 1
Composition of the hydrophilicizing agents

| | component | blending | component | blending | component | blending |
|---|---|---|---|---|---|---|
| | (A) | ratio | (B) | ratio | (C) | ratio |
| treatment agent (1) | A1 | 5 | B1 | 0.05 | C1 | 5 |
| treatment agent (2) | A1 | 5 | B2 | 0.01 | C2 | 5 |
| treatment agent (3) | A1 | 5 | B3 | 0.5 | C1 | 5 |
| treatment agent (4) | A1 | 8 | B1 | 0.05 | C1 | 2 |
| treatment agent (5) | A1 | 3 | B1 | 0.05 | C1 | 7 |
| treatment agent (6) | A2 | 5 | B1 | 0.05 | C1 | 5 |
| treatment agent (7) | A3 | 5 | B1 | 0.05 | C1 | 5 |
| treatment agent (8) | A1 | 10 | B1 | 0.05 | — | — |
| treatment agent (9) | A1 | 2 | B1 | 0.05 | C1 | 8 |
| treatment agent | A1 | 5 | B1 | 0 | C1 | |
| (10) | | | | | | |

Notes: The blending ratio for each component represents the solids weight parts. Deionized water was used as the dilution water for each treatment agent.
abbreviations used:
A1: copolymer of acrylic acid and sulfonic group-functional acrylic acid
A2: copolymer of acrylic acid and hydroxyethyl acrylate
A3: copolymer of acrylamide and sulfonic group-functional acrylic acid
B1: catechins extracted from tea
B2: catechins extracted from dokudami (Houttuynia cordata)
B3: catechins extracted from tsubaki (Camellia japonica)
C1: polypropylene glycol diglycidyl ether
C2: polyethylene glycol diglycidyl ether

Table 2 reports the hydrophilicizing agents (1) through (10) and treatment conditions used in each of Examples 1 through 9 and Comparative Example 1. Hydrophilicizing agents (1) through (9) were used in Examples 1 through 9, while hydrophilicizing agent (10), which had a composition outside the range of the invention, was used in Comparative Example 1. Table 3 reports the results of property evaluation for the hydrophilicized specimens from Examples 1 through 9 and Comparative Example 1.

TABLE 2
Hydrophilicizing agents and treatment conditions

| | | | |
|---|---|---|---|
| | heating/ | heating/ | dry |
| | drying | drying | coating |
| | temperature | time | weight |
| treatment agent | ° C. | seconds | g/m² |

| | | | | |
|---|---|---|---|---|
| Example 1 | treatment agent (1) | 220 | 30 | 1 |
| Example 2 | treatment agent (2) | 220 | 30 | 1 |
| Example 3 | treatment agent (3) | 220 | 30 | 1 |
| Example 4 | treatment agent (4) | 220 | 30 | 1 |
| Example 5 | treatment agent (5) | 220 | 30 | 1 |
| Example 6 | treatment agent (6) | 220 | 30 | 1 |
| Example 7 | treatment agent (7) | 220 | 30 | 1 |
| Example 8 | treatment agent (8) | 220 | 30 | 1 |
| Example 9 | treatment agent (9) | 220 | 30 | 1 |
| Comp. Ex. 1 | treatment agent (10) | 220 | 30 | 1 |

TABLE 3
Results of the property evaluation tests

| | hydrophilicity | | odor evaluation | | | deodorizing activity | | |
|---|---|---|---|---|---|---|---|---|
| | | elapsed | | elapsed | | | | methyl |
| | initial | time | initial | time | thermal | ammonia | trimethylamine | mercaptan |
| Example 1 | ++ | ++ | ++ | ++ | ++ | + | ++ | ++ |
| Example 2 | ++ | ++ | + | + | + | + | + | + |
| Example 3 | ++ | ++ | ++ | ++ | ++ | + | ++ | ++ |
| Example 4 | ++ | ++ | ++ | ++ | ++ | + | ++ | ++ |
| Example 5 | ++ | ++ | ++ | ++ | ++ | + | ++ | ++ |
| Example 6 | ++ | ++ | ++ | ++ | ++ | + | ++ | ++ |
| Example 7 | ++ | ++ | ++ | ++ | ++ | + | ++ | ++ |
| Example 8 | ++ | + | ++ | ++ | ++ | + | ++ | ++ |
| Example 9 | + | + | ++ | + | ++ | + | ++ | ++ |
| Comp. Ex. | ++ | + | Δ | Δ | x | x | x | x |
| 1 | | | | | | | | |

As shown in Table 3, the treated specimens in Examples 1 through 9, which employed the hydrophilicizing agent of this invention, had an excellent hydrophilicity, were free of offensive odor both initially and after thermal challenge, and had a deodorizing activity that reduced the concentration of offensive odor substances.

In contrast, Comparative Example 1 did not employ the phenolic compound (B) and as a consequence had a poorer ability to avoid offensive odor evolution and was entirely unable to develop a deodorizing activity.

The hydrophilic coatings formed on aluminiferous metal surfaces using the inventive hydrophilicizing agent exhibit an excellent hydrophilicity even after elapsed time. These coatings are initially free of odor and also avoid offensive odor evolution after being subjected to a heating episode that would ordinarily degrade organic substances. In addition, these coatings exhibit a high deodorizing activity and, when present in an ambient containing various offensive odor substances, have the ability to reliably reduce the level of these substances.

As a consequence of these features, the inventive hydrophilicizing agent has a very high practical utility, is very well suited for application to the aluminiferous materials used in air conditioner heat exchangers, and can be used in a broad range of other applications.

What is claimed is:

1. A hydrophilicizing agent for aluminiferous metals comprising:
(A) at least one water-soluble polymer having a main chain to which is bonded at least one functional group selected from the group consisting of carboxyl groups, amide groups, hydroxyl groups, sulfonic acid groups and phosphonic acid groups; and
(B) at least one phenolic compound in which at least five hydroxyl groups are directly bonded to a polycyclic structure comprising at least one aromatic ring.

2. The hydrophilicizing agent of claim 1 additionally comprising (C) at least one glycidyl-functional organic compound.

3. The hydrophilicizing agent of claim 1 or 2 wherein at least one phenolic compound is selected from polyhydroxy compounds with structural formula (I): 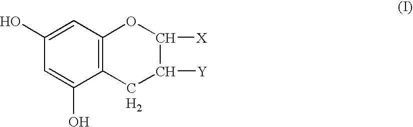
wherein:
X represents an aromatic group that is substituted by at least two hydroxyl groups and
Y is a hydroxyl group or an aromatic group with formula (II).

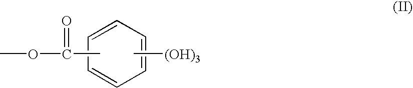

4. The hydrophilicizing agent of claim 1, 2 or 3 wherein at least one phenolic compound is selected from (+)-catechin, (−)-epicatechin, (+) -gallocatechin, (−)-epicatechin gallate, (−)-epigallocatechin gallate, and (−)-epigallocatechin.

5. The hydrophilicizing agent of claim 2, 3, or 4 wherein the weight ratio of component (A) to component (C) is from 9:1 to 3:7.

6. The hydrophilicizing agent of claim 2, 3, 4 or 5 wherein the weight ratio of component (B) to the total of component (A) and component (C) is from 1:1000 to 1:20.

7. A method of rendering a surface of an aluminiferous metal hydrophilic, said method comprising the steps of:
(a) applying a hydropilicizing agent in accordance with claim 1, 2, 3, 4, 5 or 6 to said surface and
(b) heating and drying the applied hydrophilicizing agent to form a hydrophilic coating layer on said surface.
